(19) United States
(12) Patent Application Publication
(10) Pub. No.: US 2025/0383857 A1
(43) Pub. Date: Dec. 18, 2025

(54) SOFTWARE INSTALLATION FILE GENERATION METHOD AND SOFTWARE INSTALLATION FILE GENERATION SYSTEM

(71) Applicant: Getac Technology Corporation, New Taipei City (TW)

(72) Inventor: Chia-Chang CHIU, Taipei City (TW)

(21) Appl. No.: 19/172,974

(22) Filed: Apr. 8, 2025

(30) Foreign Application Priority Data
Jun. 18, 2024 (TW) 113122492

(51) Int. Cl. G06F 8/61; G06F 8/65; G06F 8/71; H04L 9/40

(52) U.S. Cl. CPC G06F 8/63; G06F 8/65; G06F 8/71; H04L 63/0428

(57) ABSTRACT

A software installation file generating method applied in a software installation file generating system. The software installation file generating method includes receiving a software order of an electronic device through a software compiling server, reading a hardware serial number corresponding to the software order from a hardware S/N record through the software compiling server, generating a software installation file in real-time through the software compiling server based on the hardware serial number of the electronic device, and sending the software installation file to the electronic device to the software compiling server.

### CROSS-REFERENCE TO RELATED APPLICATION

This application claims priority to Taiwan Application Serial Number 113122492, filed Jun. 18, 2024, which is herein incorporated by reference in its entirety.

### BACKGROUND

### Field of Invention

The present disclosure relates to a software installation file generation system and software installation file generation method.

### Description of Related Art

Traditional software license management systems rely on pre-collected hardware purchase order data to bind and distribute software licenses. This mode of operation has a high reliance on data synchronization and has limited adaptability in dynamic environments.

Accordingly, how to provide a software authorization method and system that does not rely on a hardware order is still a goal in this field.

### SUMMARY

One aspect of the present disclosure is a software installation file generation method applied in a software installation file generation system.

In an embodiment of the present disclosure, the software installation file generation method includes receiving a software order of an electronic device through a software compiling server; reading a hardware serial number corresponding to the software order from a hardware serial number record through the software compiling server; generating a software installation file in real-time through the software compiling server based on the hardware serial number of the electronic device; and distributing the software installation file through the software compiling server to the electronic device.

In an embodiment of the present disclosure, the software installation file generation method further includes receiving a registration information of the electronic device through an activation server before receiving the software order of the electronic device through the software compiling server; detecting the hardware serial number of the electronic device based on the registration information through the activation server; and storing the hardware serial number to the hardware serial number record of the software compiling server through the activation server.

In an embodiment of the present disclosure, the software installation file generation method further includes sending a certificate to the electronic device based on the registration information through the activation server.

In an embodiment of the present disclosure, the software installation file generation method further includes detecting a software update item before the software installation file is generated in real-time by the software compiling server based on the hardware serial number of the electronic device.

In an embodiment of the present disclosure, when detecting the software update item, the software installation file generation method further includes receiving a software update source code through the software compiling server; and compiling the software update source code and generating an updated software installation file in real-time based on the hardware serial number of the electronic device.

In an embodiment of the present disclosure, reading the hardware serial number corresponding to the software order from a hardware serial number record through the software compiling server further includes enabling the hardware serial number as an enabled hardware serial number.

In an embodiment of the present disclosure, generating the software installation file in real-time through the software compiling server based on the hardware serial number of the electronic device further includes reading a software source code corresponding to the software order through the software compiling server.

In an embodiment of the present disclosure, generating the software installation file in real-time through the software compiling server based on the hardware serial number of the electronic device further includes detecting a software version information of the software order through the software compiling server; and generating the software installation file based on the software version information and a specification of the electronic device through the software compiling server, such that the software installation file is particularly used for the electronic device.

In an embodiment of the present disclosure, distributing the software installation file through the software compiling server to the electronic device further includes receiving the software installation file through a System Center Configuration Manager (SCCM) or a Microsoft System Deployment Toolkit (MDT) by the electronic device.

In an embodiment of the present disclosure, distributing the software installation file through the software compiling server to the electronic device further includes encrypting the software installation file.

Another aspect of the present disclosure is a software installation file generation system.

In an embodiment of the present disclosure, the software installation file generation system includes an electronic device, a software compiling server configured to receive a software order of the electronic device, and a storage device connecting with the software compiling server and is configured to store a hardware serial number record. The software compiling server is configured to read a hardware serial number corresponding to the software order from the hardware serial number record, and is configured to generate a software installation file in real-time based on the hardware serial number of the electronic device.

In an embodiment of the present disclosure, the software installation file generation system further includes an activation server configured to receive a registration information of the electronic device, detect the hardware serial number of the electronic device, and store the hardware serial number to the hardware serial number record of the storage device.

In an embodiment of the present disclosure, the activation server is configured to send a certificate to the electronic device based on the registration information.

In an embodiment of the present disclosure, the software compiling server is further configured to detect a software update item. When detecting the software update item, the software compiling server is configured to receive a software update source code and is configured to compile the software update source code to generate an updated software installation file.

In an embodiment of the present disclosure, the software compiling server is configured to read the software update source code corresponding to the software order.

In an embodiment of the present disclosure, the software compiling server is further configured to detect a software version information of the software order, generate the software installation file based on the software version information and a specification of the electronic device, and particularly use the software installation file to the electronic device.

In an embodiment of the present disclosure, the software installation file generation system further includes a system center configuration manager or a system deployment toolkit configured to receive the software installation file.

In an embodiment of the present disclosure, the software compiling server is configured to distribute the software installation file to the electronic device and encrypt the software installation file.

In the foregoing embodiments, the software installation file generation system and generation method of the present disclosure do not need to distribute software authorization by binding the hardware purchase order data in advance. Instead, the software installation file is generated in real-time according to the hardware serial number of the end user, which can improve system flexibility and user experience. This method can be adapted to rapid change in hardware environment and meet users' needs for software installation files in real-time, thereby improving system operating efficiency and user satisfaction.

### BRIEF DESCRIPTION OF THE DRAWINGS

The disclosure can be more fully understood by reading the following detailed description of the embodiment, with reference made to the accompanying drawings as follows:

FIG. 1 is a block diagram of a software installation file generation system according to one embodiment of the present disclosure.

FIG. 2 is a flow chart of a software installation file generation method according to one embodiment of the present disclosure.

FIG. 3 is a flow chart of a software installation file generation method according to one embodiment of the present disclosure.

FIG. 4 is a flow chart of steps of generating a software installation file in real-time according to one embodiment of the present disclosure.

FIG. 5 is a flow chart of the steps of distributing the software installation file through the software compiling server to the electronic device.

FIG. 6 is a flow chart of a software installation file generation method according to another embodiment of the present disclosure.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

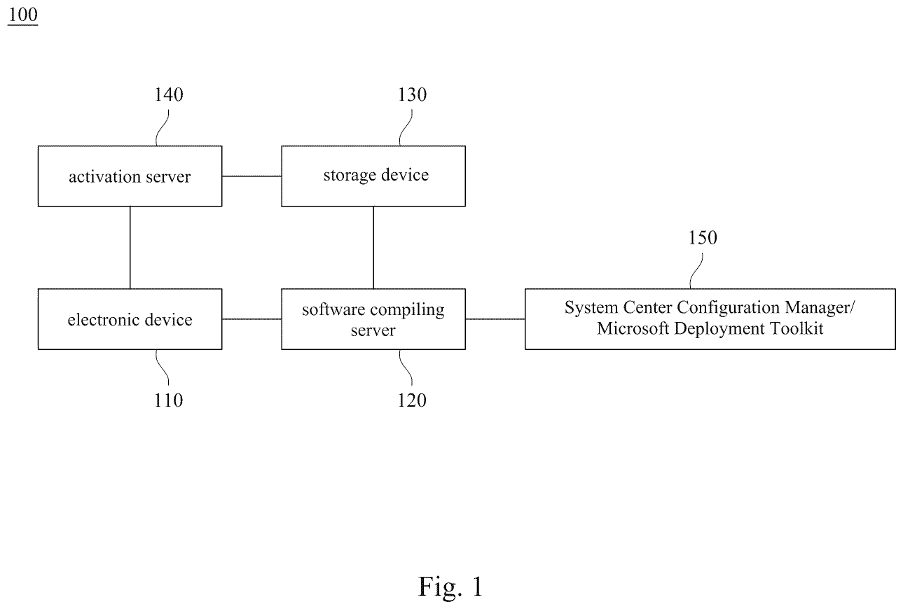

FIG. 1 is a block diagram of a software installation file generation system 100 according to one embodiment of the present disclosure. The software installation file generation system 100 includes an electronic device 110, a software compiling server 120, a storage device 130, an activation server 140, and a system management platform 150 connected through internet. The system management platform 150 is a system manage software and includes System Center Configuration Manager (SCCM) or Microsoft Deployment Toolkit (MDT). The implementation method of the system management platform 150 can be a server with the system manage software installed.

The electronic device 110 is a terminal device, and the implementation methods may include, but are not limited to, personal computers, laptops, tablets, and mobile communication devices. The network connection conforms to a communication standard for IEEE 802.11 (e.g., Wi-Fi), Bluetooth, ZigBee, NFC, or any other appropriate wireless communication. In some embodiments, the communication device may be, for example, but not limited to, a device that conforms to a communication standard for Ethernet, Universal Serial Bus (USB) or any other suitable wired transmission.

The software compiling server 120 is configured to receive the software order of the electronic device 110. The storage device 130 is connected with the software compiling server 120 and is used for storing the hardware serial number record. The software compiling server 120 is configured to read the hardware serial number corresponding to the software order from the hardware serial number record of the storage device 130, and is configured to generate a software installation file in real-time according to the hardware serial number of the electronic device 110. The activation server 140 is configured to receive registration information of electronic device 110, detect the hardware serial number of electronic device 110 based on the registration information, and store hardware serial number to a hardware serial number record of storage device 130.

The software compiling server 120 and the activation server 140 include a processor and a storage device, and the implementation methods of the processor may include a central processing unit (central processing unit, CPU), or other programmable general-purpose or special-purpose micro control unit (MCU), microprocessor, digital signal processor (DSP), programmable controller, application specific integrated circuit (ASIC), graphics processing unit (GPU), arithmetic logic unit (ALU), complex programmable logic device (CPLD), field programmable gate array (FPGA), other similar components, or a combination thereof.

Implementation methods of the storage device 130 and the storage device contained in the software compiling server 120 and the activation server 140 include any type of fixed or removable random access memory (RAM), read-only memory (ROM), flash memory (flash memory), hard disk drive (HDD), Solid state drive (SSD), similar elements, or a combination of the above.

System Center Configuration Management (SCCM) and system deployment toolkit (MDT) (system management platform 150) are configured to receive software installation files. The System Center Configuration Management is configured to manage and send software update data, test and deploy software updates, and track the software update status of the electronic devices 110 of end users to improve security.

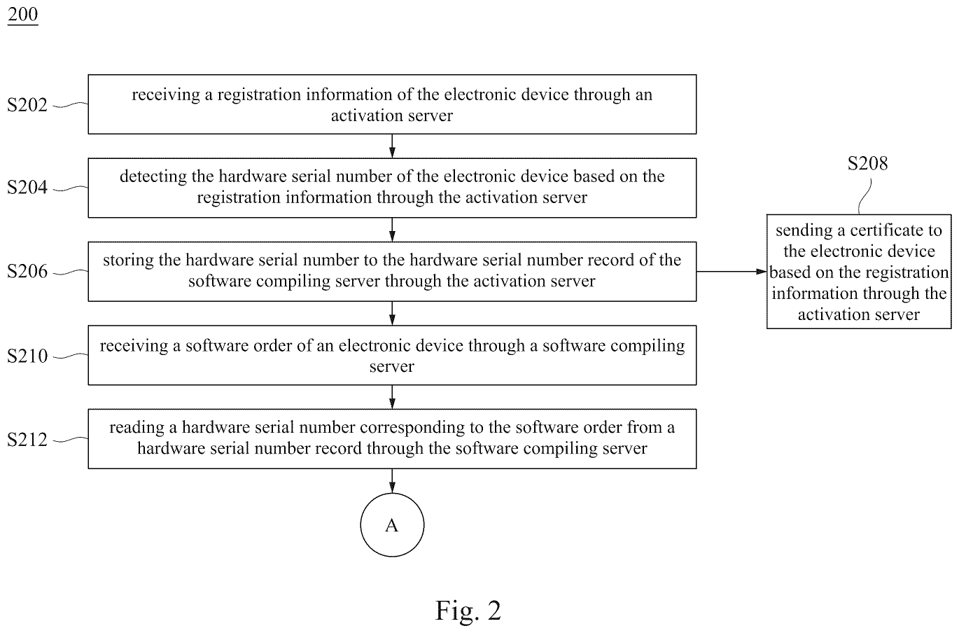

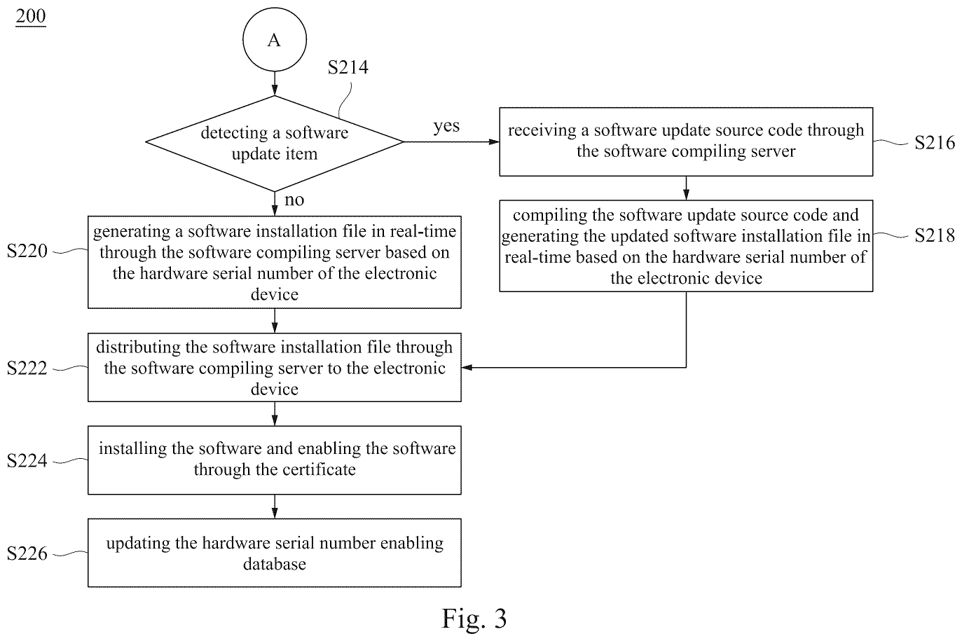

FIG. 2 and FIG. 3 are flow charts of a software installation file generation method 200 according to one embodiment of the present disclosure. Reference is made to FIG. 1 and FIG. 2. The software installation file generation method 200 is applied in the software installation file generation system 100. The software installation file generation method 200 begins with step S202, a registration information of the electronic device 110 is received by the activation server 140. In this step, the electronic devices 110 of end users are connected to the activation server 140 via network and are registered. Continuing to step S204, the hardware serial number of the electronic device 110 is detected by the activation server 140 based on the registration information. Continuing to step S206, the hardware serial number is stored to the hardware serial number record of the software compiling server 120 through the activation server 140. The hardware serial number record is stored in the storage device 130.

The software installation file generation method 200 proceeds to step S208, a certificate is sent to the electronic device 110 through the activation server 140 based on the registration information. The activation server 140 may be configured to receive registration requests from multiple end users, and may process and send corresponding certificates to the electronic device 110 of each end user.

The software installation file generation method 200 proceeds to step S210, in which the software order of electronic device 110 is received through the software compiling server 120. In this step, the software order sent to the software compiling server 120 can be a Purchase Order.

The software installation file generation method 200 proceeds to step S212, in which the hardware serial number corresponding to the software order is read from the hardware serial number record through the software compiling server. In some embodiments, the hardware serial number is stored in the storage device 130 in step S206. In other embodiments, steps S202 to S206 may be omitted, and the hardware serial number is detected in real-time after the software order is issued.

Reference is made to FIG. 1 and FIG. 3. The software installation file generation method 200 proceeds to step S214 to detect a software update item. Software update items are software update source codes provided by developers. Continuing to step S216, when detecting the software update item in step S214, the software compiling server 120 receives the software update source code. Continuing to step S218, the software compiling server 120 compiles the software update source code and generates an updated software installation file in real-time according to the hardware serial number of the electronic device 110.

When detecting no software update item in step S214 of the software installation file generation method 200, the method proceeds to step S220 to generate a software installation file in real-time through the software compiling server 120 based on the hardware serial number of the electronic device 110. Continuing to step S222, the software installation file is distributed to the electronic device 110 through the software compiling server 120.

The software installation file generation method 200 proceeds to step S224. The end users who receive the software installation file connect to the network to install the software and enable the software through the certificate.

The software installation file generation method 200 proceeds to step S226 to update the hardware serial number enabling database and store the sent software installation file version and hardware serial number information in the hardware serial number enabling database. The hardware serial number enabling database may be stored in the storage device 130. In other words, the hardware serial number enabling database is the hardware serial numbers that have been enabled and can be included in the hardware serial number record.

In the above method, there is no need to distribute software licenses by binding hardware purchase order data in advance. Instead, the software installation file is generated in real-time based on the hardware serial number of the end users, which can improve system flexibility and user experience. This method can be adapted to rapid change in hardware environment and meet users' needs for software installation files in real-time, thereby improving system operating efficiency and user satisfaction.

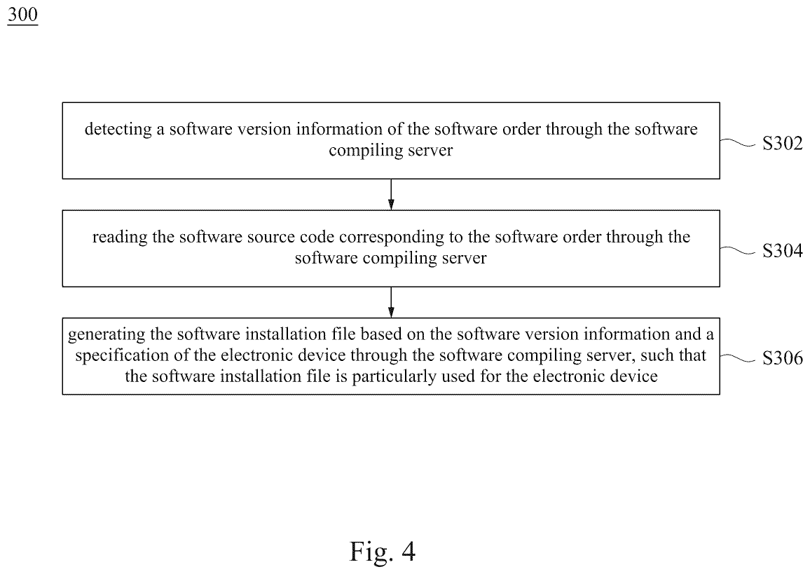

FIG. 4 is a flow chart of steps of generating a software installation file in real-time according to one embodiment of the present disclosure. Step 300 of generating a software installation file in real-time is substantially equivalent to step S220 in FIG. 3. Reference is made to FIG. 1 and FIG. 4. The step 300 of generating a software installation file in real-time is used to generate a customized software installation file. The step 300 of generating a software installation file in real-time includes step S302, step S304 and step S306. In step S302, the software compiling server 120 detects a software version information of the software order. In step S304, the software compiling server 120 reads the software source code corresponding to the software purchase order. In step S306, the software compiling server 120 generates a software installation file according to the software version information and the specification of the electronic device 110, so that the software installation file is particularly used for the electronic device 110. Different electronic devices 110 have different software version requirements. The software compiling server 120 automatically detects the version information to ensure that the generated software installation file is suitable for the specifications of the electronic device 110.

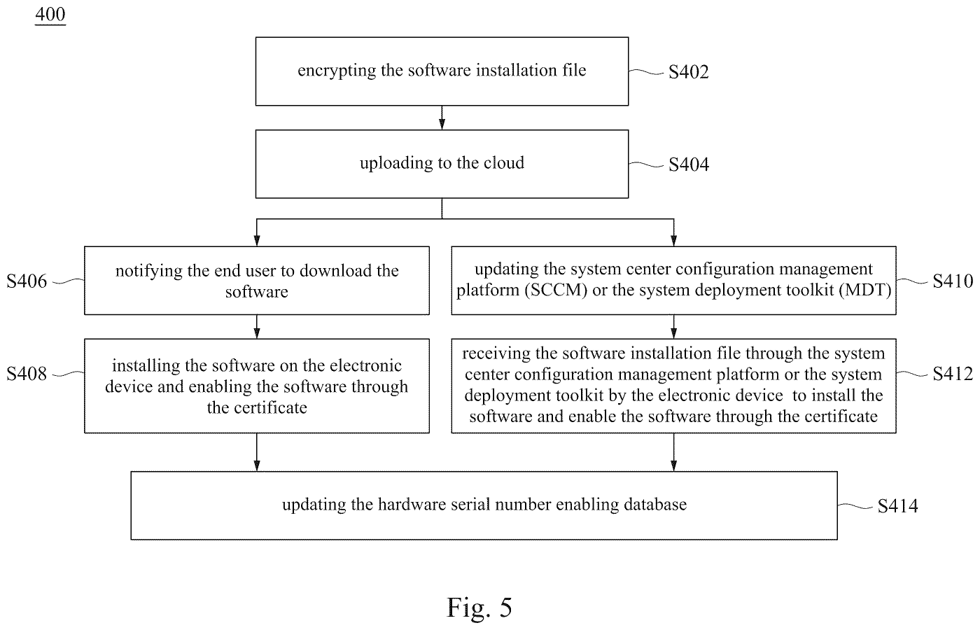

FIG. 5 is a flow chart of step 400 of distributing a software installation file through the software compiling server to an electronic device according to an embodiment of the present disclosure. Reference is made to FIG. 1 and FIG. 5. The step 400 of distributing the software installation file through the software compiling server 120 to the electronic device 110 includes step S402 of encrypting the software installation file, such as signing a digital signature. The signed software installation file is distributed to the end users or transmitted to the system management platform 150 through a transmission security agreement to ensure the security and integrity of the software during transmission.

Step 400 of distributing the software installation file through the software compiling server 120 to the electronic device 110 proceeds to step S404, where the encrypted software installation file is uploaded to the cloud. In some embodiments, step 400 of distributing the software installation file through the software compiling server 120 to the electronic device 110 proceeds to step S406 of notifying the end user to download the software. Continuing to step S408, the end user installs the software on the electronic device 110 and enables the software through the certificate.

In another embodiment, step 400 of distributing the software installation file through the software compiling server 120 to the electronic device 110 continues to step S410 to update the system center configuration management platform (SCCM) or the system deployment toolkit (MDT). In other words, end users can integrate and distribute software installation files or updated software installation files through the Central Configuration Management Platform (SCCM) or the System Deployment Toolkit (MDT). Specifically, the System Center Configuration Management Platform can also automatically check whether there is a software updates requirement and execute them regularly. Continuing to step S412, the electronic device 110 receives the software installation file through the system center configuration management platform or the system deployment toolkit to install the software and enable the software through the certificate to improve security.

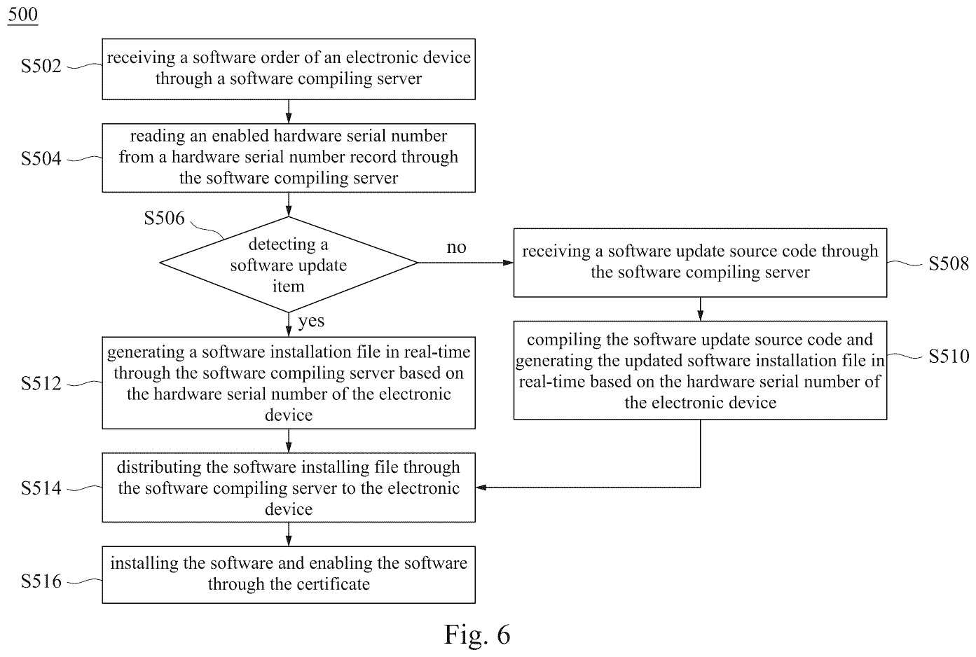

FIG. 6 is a flow chart of a software installation file generation method 500 according to another embodiment of the present disclosure. Reference is made to FIG. 1 and FIG. 6. The software installation file generation method 500 begins with step S502, where a software order of the electronic device 110 is received through the software compiling server 120. The software installation file generation method 500 proceeds to S504, where the software compiling server 120 reads the enabled hardware serial number from the hardware serial number record. As described in step S226 of the software installation file generation method 200 in FIG. 3, the hardware serial number record includes a hardware serial number enabling database that records the enabled hardware serial numbers. The subsequent steps of the software installation file generation method 500 are similar to those of the software installation file generation method 200 in FIG. 3, and therefore the description are not repeated hereinafter.

In summary, the software installation file generation system and generation method of the present disclosure do not need to distribute software authorization by binding the hardware purchase order data in advance. Instead, the software installation file is generated in real-time according to the hardware serial number of the end user, which can improve system flexibility and user experience. This method can be adapted to rapid change in hardware environment and meet users' needs for software installation files in real-time, thereby improving system operating efficiency and user satisfaction.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A software installation file generation method applied in a software installation file generation system, wherein the software installation file generation method comprises:
receiving a software order of an electronic device through a software compiling server;
reading a hardware serial number corresponding to the software order from a hardware serial number record through the software compiling server;
generating a software installation file in real-time through the software compiling server based on the hardware serial number of the electronic device; and
distributing the software installation file through the software compiling server to the electronic device.

2. The software installation file generation method of claim 1, further comprising:
receiving a registration information of the electronic device through an activation server before receiving the software order of the electronic device through the software compiling server;
detecting the hardware serial number of the electronic device based on the registration information through the activation server; and
storing the hardware serial number to the hardware serial number record of the software compiling server through the activation server.

3. The software installation file generation method of claim 2, further comprising:
sending a certificate to the electronic device based on the registration information through the activation server.

4. The software installation file generation method of claim 1, further comprising:
detecting a software update item before the software installation file is generated in real-time by the software compiling server based on the hardware serial number of the electronic device.

5. The software installation file generation method of claim 4, wherein when detecting the software update item, the software installation file generation method further comprises:
receiving a software update source code through the software compiling server; and
compiling the software update source code and generating an updated software installation file in real-time based on the hardware serial number of the electronic device.

6. The software installation file generation method of claim 1, wherein reading the hardware serial number corresponding to the software order from a hardware serial number record through the software compiling server further comprises:
enabling the hardware serial number as an enabled hardware serial number.

7. The software installation file generation method of claim 1, wherein generating the software installation file in real-time through the software compiling server based on the hardware serial number of the electronic device further comprises:
reading a software source code corresponding to the software order through the software compiling server.

8. The software installation file generation method of claim 1, wherein generating the software installation file in real-time through the software compiling server based on the hardware serial number of the electronic device further comprises:
detecting a software version information of the software order through the software compiling server; and
generating the software installation file based on the software version information and a specification of the electronic device through the software compiling server, such that the software installation file is particularly used for the electronic device.

9. The software installation file generation method of claim 1, wherein distributing the software installation file through the software compiling server to the electronic device further comprises:
receiving the software installation file through a System Center Configuration Manager (SCCM) or a Microsoft System Deployment Toolkit (MDT) by the electronic device.

10. The software installation file generation method of claim 1, wherein distributing the software installation file through the software compiling server to the electronic device further comprises:
encrypting the software installation file.

11. A software installation file generation system, comprising:
an electronic device;
a software compiling server configured to receive a software order of the electronic device; and
a storage device connecting with the software compiling server and is configured to store a hardware serial number record, wherein the software compiling server is configured to read a hardware serial number corresponding to the software order from the hardware serial number record, and is configured to generate a software installation file in real-time based on the hardware serial number of the electronic device.

12. The software installation file generation system of claim 11, further comprising:
an activation server configured to receive a registration information of the electronic device, detect the hardware serial number of the electronic device, and store the hardware serial number to the hardware serial number record of the storage device.

13. The software installation file generation system of claim 12, wherein the activation server is configured to send a certificate to the electronic device based on the registration information.

14. The software installation file generation system of claim 11, wherein the software compiling server is further configured to detect a software update item, wherein when detecting the software update item, the software compiling server is configured to receive a software update source code and is configured to compile the software update source code to generate an updated software installation file.

15. The software installation file generation system of claim 14, wherein the software compiling server is configured to read the software update source code corresponding to the software order.

16. The software installation file generation system of claim 11, wherein the software compiling server is further configured to detect a software version information of the software order, generate the software installation file based on the software version information and a specification of the electronic device, and particularly use the software installation file on the electronic device.

17. The software installation file generation system of claim 11, further comprising:
a system center configuration manager or a system deployment toolkit configured to receive the software installation file.

18. The software installation file generation system of claim 11, wherein the software compiling server is configured to distribute the software installation file to the electronic device and encrypt the software installation file.
